(19) United States
(12) Patent Application Publication
(10) Pub. No.: US 2026/0200609 A1
(43) Pub. Date: Jul. 16, 2026

(54) COLLISION-RESILIENT QUADROTOR WITH COLLISION-COMPLIANT PROPELLERS AND L1QUAD ARCHITECTURE

(71) Applicant: The Board of Trustees of the University of Illinois, Urbana, IL (US)

(72) Inventors: Naira Hovakimyan, Champaign, IL (US); Sheng Cheng, Champaign, IL (US); Ziyin Han, Urbana, IL (US); Chengyu Yang, Champaign, IL (US); Van Anh Ho, Kanazawa (JP); Hung Tien Pham, Nomi (JP); Quan Khanh Luu, West Lafayette, IN (US)

(21) Appl. No.: 19/415,200

(22) Filed: Dec. 10, 2025

Related U.S. Application Data
(60) Provisional application No. 63/745,220, filed on Jan. 14, 2025.

(51) Int. Cl. B64U 40/10; B64U 10/14; B64U 20/30; B64U 30/293

(52) U.S. Cl. CPC B64U 40/10; B64U 10/14; B64U 20/30; B64U 30/293; B64U 2201/10

(57) ABSTRACT

A feedback control system includes a quadrotor equipped with collision-compliant propellers, a computing system coupled to the quadrotor, and a summer. The computing system is configured to implement a geometric control component responsive to position and velocity reference values in relation to an output state of the quadrotor, which output state is affected by impacts against the collision-compliant propellers, and implement an [symbol] ₁ adaptive control component that is responsive to a combination of the output state and an input control signal to the quadrotor. The summer generates the input control signal by combining an output control signal of the geometric control component with a adaptive signal of the [symbol] ₁ adaptive control component such as to compensate for uncertainties and disturbances using the [symbol] ₁ adaptive control component.

### CLAIM OF PRIORITY

The present application claims the benefit under 35 U.S.C. § 119(e) of U.S. Provisional Patent Application No. 63/745,220 filed Jan. 14, 2025, which is incorporated herein by this reference.

### STATEMENT CONCERNING FEDERALLY SPONSORED RESEARCH OR DEVELOPMENT

This invention was made with government support under FA2386-22-1-4033 awarded by the Asian Office of Aerospace Research and Development (AOARD) Basic Research, 80NSSC22M0070 awarded by the University Leadership Initiative at NASA, and 2133656 awarded by National Science Foundation (NSF)-AoF Robust Intelligence. The government has certain rights in the invention.

### TECHNICAL FIELD

Embodiments of the disclosure relate generally to quadrotors, and more specifically, relate to collision-resilient quadrotor with collision-compliant propellers and [symbol] ₁ Quad architecture.

### BACKGROUND

Quadrotors are the most common unmanned aerial vehicles (UAVs) today, widely used in fields like infrastructure inspection, crop monitoring, search and rescue, delivery, and filming. Their popularity comes from advantages such as their simple construction, ease of control, and low cost. However, they also present risks, including potential collisions that lead to injury or damage, highlighting the need for enhanced safety measures. Although onboard sensors (ultrasonic sensors, radar, monocular/stereo cameras) can detect nearby obstacles, a collision-resilient solution protects against damage as a result of unavoidable collisions, especially in highly dynamic and unstructured environments.

Existing works focus on hardware improvements to provide protection to the UAV from external objects, such as origami-based cover and propeller guards. In addition, several studies improve structural designs using soft materials to mitigate risks during collisions. Such studies use soft materials to build the quadrotor arms and specially designed structures to protect the propellers from impacts. Few other efforts apply soft materials in the design and manufacturing of propellers, such as the use of polyester film, e.g., polyethylene terephthalate (PET), or thermoplastic polyurethane (TPU). An alternative method involves the direct use of soft materials in propeller manufacturing.

### BRIEF DESCRIPTION OF THE DRAWINGS

A more particular description of the disclosure briefly described above will be rendered by reference to the appended drawings. Understanding that these drawings only provide information concerning typical embodiments and are not therefore to be considered limiting of its scope, the disclosure will be described and explained with additional specificity and detail through the use of the accompanying drawings.

FIG. 1A is an operational schematic diagram illustrating a feedback control system employing the [symbol] ₁ Quad architecture of a quadrotor using the collision-compliant (or Tombo) propeller, which was referenced previously, according to some embodiments.

FIG. 1B is an example quadrotor, such as the quadrotor of FIG. 1A, with directional references according to an embodiment.

FIG. 1C is an example quadrotor model consistent with the quadrotor of FIG. 1A according to some embodiments.

FIG. 2 is a perspective view of the quadrotor with the collision-complaint propeller during collision according to various embodiments.

FIG. 3 is a set of images illustrating body-fixed frame and an inertial frame according to some embodiments.

FIG. 4 is an implementation guide of an algorithm of the [symbol] ₁ Quad architecture according to some embodiments.

FIG. 5 is a set of graphs illustrating altitude error before and after collision with a foam bar according to some embodiments.

FIG. 6A is a quadrotor with the collision-compliant propeller colliding with a form bar according to some embodiments.

FIG. 6B is a quadrotor with the collision-compliant propeller colliding with a carbon fiber bar according to some embodiments.

FIG. 7A is a set of graphs illustrating statistics of recovery time and maximum deviation distance after collision with a foam bar according to at least one embodiment.

FIG. 7B is a set of graphs illustrating statistics of recovery time and maximum deviation distance after collision with a carbon fiber bar according to at least one embodiment.

FIG. 8 illustrates a sever collision setup that uses a carbon fiber rod that intrudes into a path of the propeller according to an embodiment.

FIG. 9A is a quadrotor after a severe collision along with a collided-with soft propeller according to an embodiment.

FIG. 9B is a quadrotor after a severe collision along with a collided-with rigid propeller, which is broken, according to an embodiment.

FIG. 10A is a graph of trajectory of a quadrotor in a severe collision with soft propellers according to an embodiment.

FIG. 10B is a graph of trajectory of the quadrotor in a severe collision with rigid propellers according to an embodiment.

FIG. 11 is a flow chart of a method for operating a control feedback system employing the [symbol] ₁ Quad architecture of a quadrotor using the collision-compliant (or Tombo) propeller according to some embodiments.

FIG. 12 is a computing system configured to perform at least some of the operations discussed herein according to some embodiments.

While embodiments of the present disclosure are susceptible to various modifications and alternative forms, exemplary embodiments thereof are shown by way of example in the drawings and are herein described in detail. It should be understood, however, that the description of exemplary embodiments is not intended to limit the disclosure to the particular forms disclosed, but on the contrary, the intention is to cover all modifications, equivalents and alternatives falling within the spirit and scope of the in accordance with one or more embodiments of the present disclosure.

### DETAILED DESCRIPTION

The technology now will be described more fully hereinafter with reference to the accompanying drawings, in which some, but not all embodiments are shown. Indeed, the disclosure may be embodied in many different forms and should not be construed as limited to the embodiments set forth herein; rather, these embodiments are provided so that this disclosure will satisfy applicable legal requirements.

Likewise, many modifications and other embodiments of the technology described herein will come to mind to one of skill in the art to which the disclosure pertains having the benefit of the teachings presented in the enclosed descriptions and the associated drawings. Therefore, it is to be understood that the disclosure is not to be limited to the specific embodiments disclosed and that modifications and other embodiments are intended to be included within the scope of this disclosure. Although specific terms are employed herein, they are used in a generic and descriptive sense only and not for purposes of limitation.

Unless defined otherwise, all technical and scientific terms used herein have the same meaning as commonly understood by one of skill in the art to which embodiments described herein pertain. Although any methods and materials similar to or equivalent to those described herein can be used in the practice or testing of embodiments of the present disclosure, the preferred methods and materials are described herein.

Although hardware solutions can improve safety during collisions, post-collision recovery strategies can also be considered to enable the quadrotor to quickly resume operation after collisions. Early studies focused on collision detection, followed by post-collision recovery strategies. Some researchers have used an inertial measurement unit (IMU) onboard to detect collisions on the quadrotor frame through sudden changes in acceleration, and the system could recover quickly. Others investigated the dynamics of collision between a quadrotor with protected propellers and a vertical pole, in which collision detection is performed by examining sudden changes in the horizontal components of the accelerometer positioned close to the quadrotor's center of gravity. Upon detecting a collision, the recovery control maneuvers the vehicle away from the obstacle while maintaining an upright attitude. Still others proposed a drone arm design that combines a shock absorber mechanism and a prismatic joint integrated with a Hall sensor to detect collisions. When a collision occurs, the quadrotor is controlled to move in the direction opposite to the collision, covering a distance that corresponds to the intensity of the collision. Other solutions apply to small quadrotors for collision resistance that equips them with soft coil spring force sensors. These sensors enable passive resistance and detect physical contact or collisions.

The studies mentioned above focus primarily on detecting and recovering from collisions involving the quadrotor frame, which cannot address the collisions involving the propellers. This scenario is more critical than the collisions of the quadrotor frame because it leads to potential loss of actuation, which compromises the quadrotor's maneuverability. Given that propellers rotate at high speeds, pinpointing the exact location and direction of impact on the quadrotor is challenging. Additionally, there is a risk of propeller breakage during collisions, making post-collision recovery more challenging and increasing the likelihood of a crash. Although previous studies on soft propellers have demonstrated their ability to withstand and recover from damage after impact, they focus mainly on recovery strategies in a hover-collision-hover scenario without addressing collisions amid trajectory-based flights that are more dynamic and collision-prone.

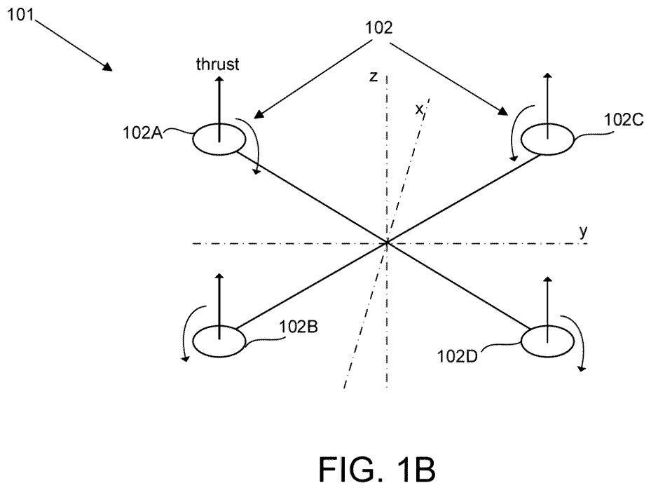

Research of the inventors demonstrates a collision-compliant soft propeller 102, named the “Tombo” propeller in some works (see FIG. 2), which can recover normal flight after collisions by directing the quadrotor away from the collision point and then returning to a recovery position. This collision-compliant propeller 102 provides the foundation for understanding how deformable propellers can enhance post-collision resilience. Notably, the collision-compliant propellers have a nodus made of soft material that allows them to fold upon impact. However, the soft nodus leads to a changing aerodynamic force generated by the collision-compliant propellers compared to the conventional (rigid) propellers, and it further causes oscillations in the propeller 102 during sudden motor accelerations and de-accelerations. Moreover, owing to the deformable property, the system's dynamics will become unpredictable upon a collision between the collision-compliant propeller 102 and the environment. These uncertainties and disturbances limit the quadrotor's flight envelope and present challenges in controller design and tuning.

In recent years, unmanned aerial vehicles have seen an increased use across a wide range of applications. The quadrotor platform, in particular, has garnered interest due to its low cost, relatively simple mechanical structure, and dynamic capabilities. Controller synthesis for quadrotors is a challenging problem due to the unstable and underactuated nature of the dynamics. The challenges are exacerbated further due to uncertainties and disturbances (e.g., wind, payload sloshing, and system degradation), potentially leading to a loss of predictability and even stability.

To design controllers for the underactuated dynamics of quadrotors that evolve on the special Euclidean group, SE(3), early studies adopt the linearized quadrotor dynamics at the equilibrium point around hover state, which can lead to poor performance. (The special Euclidean group SE(3) is used to describe the translational and rotational motion of an object.) Nonlinear controllers such as backstepping and feedback-linearization have also been investigated. Since these methods employ Euler angles as the attitude representation that suffers from gimbal lock, they cannot perform aggressive maneuvers. Quaternions-based attitude representation has also been investigated. However, this method may cause instability to quadrotor dynamics due to unwinding phenomenon. To address this issue, geometric control theory has been adopted to derive controllers for quadrotors. This type of controller uses rotation matrices to represent attitudes that intrinsically characterize the geometric properties of nonlinear manifolds, thereby completely avoiding singularities and reducing design complexities. Following this approach, some researchers established exponential stability for the quadrotor nominal dynamics on SE(3).

Unavoidable uncertainties and disturbances in real applications further complicate quadrotor controller design. Robust and adaptive control methods have been employed to safely operate quadrotors subject to uncertainties. However, these methods assume uncertainties to be linearly dependent on known basis functions, which is restrictive. Disturbance-observer-based (DOB) methods can handle a broader class of uncertainties, yet they often assume the disturbances are generated by an exogenous system with known parameters, which is also limited. Additionally, the state dependence of uncertainties is generally ignored in the theoretical analysis of DOB methods. The control architecture proposed by some developers estimates uncertainties that require numerical differentiation of noisy signals, and the estimation accuracy is not guaranteed. Moreover, an incremental nonlinear dynamic inversion control has been applied in other works to compensate for aerodynamic drag in the quadrotor's high-speed flights. However, this sensor-based method requires the installation of extra sensors that are uncommon to typical quadrotor hardware.

Researchers have also investigated adopting machine learning (ML) tools to address uncertainties and disturbances in quadrotor control design. Early trials tried to employ deep neural network (DNNs) to represent quadrotor uncertain dynamics and then use the learned models to synthesize linear quadratic regulator (LQR) or model predictive controllers (MPC). Recent studies use ML tools to model the uncertainties and then integrate them into conventional control methods. Despite the efforts, the data collection (e.g., it is challenging to acquire data in unknown environments) and the training process form a significant overhead before the ML tools can be deployed. Additionally, when ML-based control methodologies are used, it is difficult to establish theoretical guarantees on the system's performance without making conservative assumptions. For example, some researchers use the universal approximation theorem to ensure the learned model can estimate a continuous function arbitrarily accurately. However, this theorem requires the states to remain in a compact set, which assumes the quadrotor system is stable a priori, and it is very restrictive. Furthermore, ML-based methods usually require extensive computational power and cannot be easily executed on standard quadrotor flight controllers.

The present disclosure overcomes these and other deficiencies by employing a feedback control system that includes a quadrotor equipped with collision-compliant propellers. The feedback control system includes a computing system coupled to the quadrotor. The computing system is configured to implement a geometric control component responsive to position and velocity target values in relation to an output state of the quadrotor. The output state can be affected by impacts against the collision-compliant propellers. The computing system can further implement an [symbol] ₁ adaptive control control component that is responsive to a combination of the output state and an input control signal to the quadrotor. A summer can generate the input control signal by combining an output control signal of the geometric control component with an adaptive signal of the [symbol] ₁ adaptive control component such as to compensate for uncertainties and disturbances using the [symbol] ₁ adaptive control component. Additional details of the feedback control system will be described hereinafter.

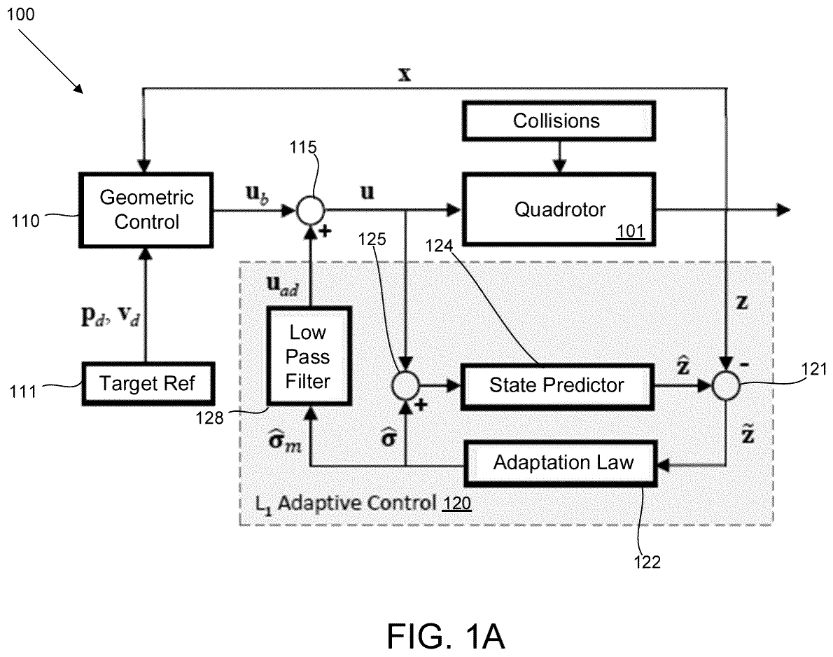

FIG. 1A is an operational schematic diagram illustrating a feedback control system 100 employing the [symbol] ₁ Quad architecture of a quadrotor 101 using the collision-compliant propeller, which was referenced previously, according to some embodiments. FIG. 1B is an example quadrotor, such as the quadrotor 101 of FIG. 1A, with directional reference according to an embodiment. In some embodiments, the quadrotor 101 is controlled by a geometric control component 110 into which is fed an output state (X) of the quadrotor 101 (e.g., a current state) and target reference values (p_{d}, v_{d}) including a three-dimensional (3D) vector of position and velocity target values for a center of mass (CoM) of the quadrotor 101. The actual input control signal (u) to the quadrotor 101 can be a combination, by a first summer 115, of the output signal (u_{b}) of the geometric control component 110 and an adaptive signal (u_{ad}) from an [symbol] ₁ adaptive control component 120.

With additional reference to FIG. 1B, the quadrotor 101 can include a number of collision-compliant propellers 102. By way of example, there can be four collision-compliant propellers 102 (or fewer or more), including a first propeller 102A, a second propeller 102B, a third propeller 102C, and a fourth propeller 102D, each which contributes to a total upward thrust to the quadrotor. Differing amounts of thrust supplied to each of the collision-compliant propeller 102 can cause a rotational shift. In embodiments, the output state (X) at any given time from the quadrotor 101 includes two sub-states, or more specifically, a translational state and a rotational state. The translational state can be understood as a combination of position and velocity for the quadrotor 101, each having a 3D value. The rotational state can be understood as a rotation matrix (which can have nine dimensions and will be discussed in more detail) and an angular velocity (which can also be a 3D value).

Thus, control of the quadrotor 101 can be in relation to this combination of translational and rotational states. The control signal provided to the quadrotor 101 can consider the current output state (X) of the quadrotor 101 along with a target reference 111 that is made up of position and velocity values (each being a 3D vector) in order to determine how to direct flight of the quadrotor 101. In this way, the [symbol] ₁ adaptive control component 120, which is layered into the control signal, can be employed to account for uncertainties in the actual output state of the quadrotor 101, as will be explained in more detail.

In embodiments, the [symbol] ₁ Quad architecture is applied to control the quadrotor 101 equipped with the collision-compliant propellers 102 (e.g., is thus a “collision-compliant” quadrotor). The “ [symbol] ₁ Quad” refers to the application of [symbol] ₁ adaptive control principles to the quadrotor 101 (e.g., to the feedback control system 100), thus designing a control framework to improve the quadrotor's stability, maneuverability, and robustness under uncertain or dynamic conditions. For example, the [symbol] ₁ Quad can be understood to be a quadrotor control architecture that uses the [symbol] ₁ adaptive control component 120 as an augmentation to compensate for the disturbances and uncertainties. The use of [symbol] ₁ adaptive control component 120 is motivated by its architectural advantage of decoupling the estimation loop from the control loop, as is illustrated in FIG. 1A, which allows the use of arbitrarily fast adaptation rates without sacrificing the robustness of the closed-loop system.

For example, in some embodiments, the [symbol] ₁ adaptive control component 120 includes a state predictor 124, an adaptation law 122, and a low pass filter 128. A second summer 121 can determine a difference or error (\tilde{z}) between a partial output state (z) of the quadrotor 101 and output states (\hat{z}) of the state predictor 124. The partial state (z) of the quadrotor 101 can include the velocity and angular velocity portions of the translational and rotation states, respectively, for example.

In some embodiments, a third summer 125 can determine the combination of an estimated uncertainty (\hat{σ}) of the adaptation law 122 and the input control signal (u) to the quadrotor 101. For example, the error (\tilde{z}) from the second summer 121 can be fed into the adaptation law 122 and the estimated uncertainty (\hat{σ}) from the adaptation law 122 can be fed into the third summer 125. An output of the third summer 125 can be fed into the state predictor 124. Further, an estimated matched uncertainty (\hat{σ}ₘ) from the adaptation law 122 can be fed into the low-pass filter 128, which outputs the adaptive signal (u_{ad}). The adaptive signal (u_{ad}) from the [symbol] ₁ adaptive control component 120 and the output signal (u_{b}) from the geometric control component 110 can be fed into the first summer 115, as was described previously, which generates the control signal (u) that actually goes to the quadrotor 101. In this way, the control loop of the geometric control component 110 and the first summer 115 is augmented by the estimation loop implemented by the illustrated [symbol] ₁ adaptive control component 120.

The feedback control system 100 can be specifically configured to compensate for uncertainties and disturbances using the [symbol] ₁ adaptive control component 120. These uncertainties and disturbances include those caused by the collision-compliant propellers 102, such as variable thrust coefficients, variable torque coefficients, voltage fluctuation effects on thrust generation, and collision-induced moments. The [symbol] ₁ adaptive control component 120 can be configured to decouple an estimation loop from a control loop implemented by the geometric control component 110, allowing for fast adaptation without compromising system robustness.

The state predictor 124 can be configured to generate predicted output states based on a nominal model of the quadrotor 101. The adaptation law 122 can be configured to estimate uncertainties based on a difference between the predicted output states and the output state of the quadrotor 101. Specifically, the adaptation law 122 can be configured to estimate matched uncertainties that affect the quadrotor 101 through a same channel as the output control signal of the geometric control component 110. These matched uncertainties include at least one of: thrust uncertainties caused by variable thrust coefficients of the collision-compliant propellers 102; moment uncertainties caused by variable torque coefficients of the collision-compliant propellers 102; voltage fluctuation effects on thrust generation; or collision-induced moments. The adaptation law 122 can further be configured to estimate unmatched uncertainties that affect the quadrotor 101 through a channel orthogonal to a channel of the output control signal.

The low-pass filter 128 can be configured to filter the estimated uncertainties to generate the adaptive signal. The state predictor 124 can be configured to be updated at a sampling rate, and a size of uniform bounds on tracking error is controllable by adjusting a bandwidth of the low-pass filter 128 and/or the sampling rate. The collision-compliant propellers 102 include a nodus made of soft material configured to fold upon impact with an obstacle, which allows the propellers to deform upon impact while maintaining structural integrity.

The output state of the quadrotor 101 can include a translational state having a position vector and a velocity vector of a center of mass of the quadrotor 101. The output state can further include a rotational state including a rotation matrix and an angular velocity vector. The geometric control component 110 can be configured to generate the output control signal based on a difference between the output state and the position and velocity target values. In embodiments, the output control signal includes a thrust command and a moment command.

To help understand the dimensionality of the different states and signals introduced above with reference to FIG. 1A, Table I illustrates the components (in 4D values) of the control signals (u, u_{b}, and u_{ad}). FIG. 1B can be referenced to understand the directional thrust and x, y, z moments.

TABLE 1

| | |
|---|---|
| total thrust (of all | 1D |
| propellers 102) | |
| moment x | 1D |
| moment y | 1D |
| moment z | 1D |

Further, Table II illustrates components of the estimated uncertainty \hat{σ} (in 6D values) and of the estimated matched uncertainty \hat{σ}ₘ (in 4D values). FIG. 1B can be referenced to further understand the x, y, z forces.

TABLE II

| | | | |
|---|---|---|---|
| force x | 1D | \hat{σ} | — |
| force y | 1D | | |
| force z (direction of total thrust) | 1D | | \hat{σ}ₘ |
| moment x | 1D | | |
| moment y | 1D | | |
| moment z | 1D | | |

In [symbol] ₁ Quad, the [symbol] ₁ adaptive control component 120 is augmented to the geometric control component 110 (as the baseline controller) through the summer 115, as was just described. The [symbol] ₁ adaptive control component 120 thus has the structural advantage of decoupling the estimation loop from the control loop, permitting rapid adaptation without compromising the robustness of the closed-loop system of the [symbol] ₁ adaptive control component 120. The [symbol] ₁ Quad can handle uncertainties and disturbances that are nonlinearly dependent on both time and states, allowing the proposed architecture to compensate for a broader class of uncertainties. Earlier work by the inventors has shown that the [symbol] ₁ Quad architecture has guarantees on transient performance in terms of uniform bounds on the error between actual states and those of a nominal system. These uniform norm bounds characterize tubes centered around the desired states so that actual states are guaranteed to stay inside these tubes despite uncertainties. Moreover, this earlier work has shown that the size of these uniform bounds can be controlled by tuning the bandwidth of the low-pass filter 128 and the sampling time of an update period of computing the control signal.

In some embodiments, the actuation-induced uncertainties caused by the collision-compliant propellers 102 (particularly those arising from propeller deformation during high-speed rotation) and disturbances resulting from collisions are modeled as described herein. These uncertainties and disturbances belong to matched uncertainties in the design of the [symbol] ₁ Quad, for which can be compensated. We experimentally validated the performance of the quadrotor 101 with collision-compliant propellers 102 and the [symbol] ₁ Quad in both collision-free and collision-involved scenarios. The results demonstrate the [symbol] ₁ Quad's consistent transient response in these scenarios, which significantly enlarges the flight envelope of a collision-compliant quadrotor.

The present disclosure is analyzed, from a control perspective, the actuation-induced uncertainties experienced by the deformable collision-compliant propellers 102 of the quadrotor 101 and the external disturbances from collisions, which offers a basis for future studies of controller design for collision-compliant quadrotors. The [symbol] ₁ Quad control architecture is applied to enhance the robustness and enlarge the flight envelope of the quadrotor 101. The effectiveness of the [symbol] ₁ Quad architecture on the quadrotor 101 is validated in both collision-free and collision-involved benchmark experiments.

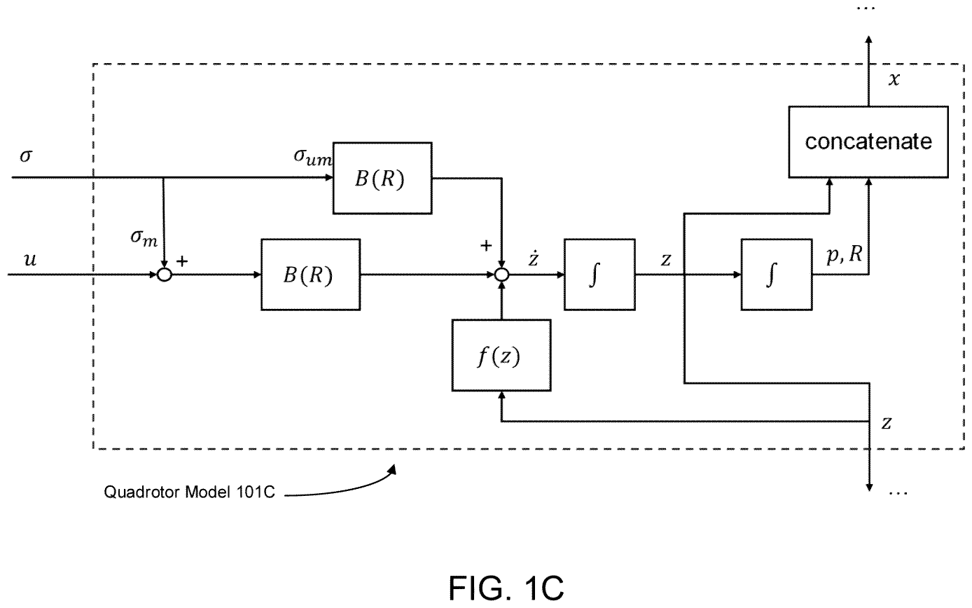

Quadrotor dynamics, including geometric control and the [symbol] ₁ Quad, are first briefly reviewed. The following notations are used throughout this disclosure. [symbol] is used to represent real numbers, the wedge operator: .\hat{ }: [symbol] ³ denotes mapping a vector to a skew-symmetric matrix, and the Vee operator.^{v} is the inverse of the wedge operator. Further, the diag (a, . . . , b) is used to denote the diagonal block matrix composed of elements a, . . . , b. The inertial frame {i₁ i₂ i₃} and the body-fixed frame {b₁ b₂ b₃} are employed in the North-East-Down coordinate system, as illustrated in FIG. 3. The body-fixed frame's origin is situated at the quadrotor's center of mass (CoM), which, given its symmetric mechanical configuration, is presumed to be its geometric center.

The equations of motion of the quadrotor 101 can be expressed as

$$\begin{matrix}\dot{p} = v , & \dot{R} = R Ω \hat{} ,\end{matrix} \qquad ( 1 a )$$

$$\begin{matrix}\dot{v} = g {e}_{3} - \frac{{T}_{c}}{m} R {e}_{3} , & \dot{Ω} = {J}^{- 1} ( {M}_{c} - Ω \times J Ω ) ,\end{matrix} \qquad ( 1 b )$$

where p is a three-dimensional vector representing the position of the quadrotor's CoM and v is a three-dimensional vector representing the velocity of the quadrotor's CoM, both of which are under the inertial frame. The rotation matrix R (a 3-by-3 matrix in the 3D rotation group) can transform the coordinates from the body-fixed frame to the inertial frame. The body-fixed axis bᵢ is given by Reᵢ in the inertial frame, where eᵢ is the unit vector with the ith entry being one (“1”). The angular velocity in the body-fixed frame is denoted by Ω, which is a three-dimensional vector; m is scalar-valued vehicle mass; g is the gravitational acceleration represented as a three-dimensional vector in the inertial frame; J is a 3-by-3 matrix representing the quadrotor's moment of inertia calculated in the body-fixed frame; T_{c} is a scalar denoting the total thrust along body-fixed frame axis b₃, and M_{c} is a three-dimensional vector representing the moments around the three body frame axes. The thrust T_{c} and moment M_{c} are the control actions, which are obtained using the geometric control component 110 in some embodiments.

The collision-compliant propellers 102 are designed to deform and recover from collisions, offering enhanced safety and resilience. However, this innovative design also introduces complexities for the controller design, which are analyzed below and shown how the complexities can be addressed by the [symbol] ₁ Quad architecture.

First are provided analysis of uncertainties and disturbances in the quadrotor 101 that employs a collisions-compliant propeller 102. As for variable thrust and torque coefficients, the collision-compliant propellers 102 have a nodus made of soft material that allows them to fold upon impact, which, however, leads to a changing thrust force and reaction torque generated by the collision-compliant propeller 102 compared to a conventional (rigid) propeller. This phenomenon can be modeled by

$${T}^{T o m b o} = {k}_{F}^{T o m b o} ( ω ) {ω}^{2} , \qquad ( 2 )$$

where ω is the rotation speed of the propeller, and

$${k}_{F}^{T o m b o} ( ω )$$

is the speed-dependent thrust coefficient. Likewise, one can write the reaction torque of the collision-compliant propeller 102 with a speed-dependent torque coefficient as

$${M}^{T o m b o} = {k}_{M}^{T o m b o} ( ω ) {ω}^{2} .$$

For conciseness, the thrust modeling in the sequel is used, where the modeling of the reaction torque follows the same logic. Besides, the collision-compliant propellers 102 are individually hand-crafted, leading to low uniformity among the four propellers 102 mounted on the quadrotor 101. In other words, for the four rotors iϵ{1, 2, 3, 4}, the individual thrust can be expressed as

$${T}_{i}^{T o m b o} = {k}_{F , i}^{T o m b o} ( {ω}_{i} ) {ω}_{i}^{2} . \qquad ( 3 )$$

In practice, for four collision-compliant propellers 102 mounted on a quadrotor 101, the thrust coefficient can be decomposed into constant (speed-independent) and variable (speed-dependent) components, i.e.,

$${k}_{F , i}^{T o m b o} ( {ω}_{i} ) = {\overline{k}}_{F}^{T o m b o} + △ {k}_{F , i}^{T o m b o} ( {ω}_{i} ) , \qquad ( 4 )$$

where

$${\overline{k}}_{F}^{T o m b o} = \frac{1}{4} {\sum }_{i = 1}^{4} {\overline{k}}_{F , i}^{Tombo}$$

is the averaged coefficient of the individual propeller's constant coefficient

$${\overline{k}}_{F , i}^{T o m b o} , and △ {k}_{F , i}^{T o m b o} ( \cdot )$$

refers to the variable component. Note that

$${\overline{k}}_{F , i}^{T o m b o}$$

can be fitted from the thrust-speed curve with steady-state measurements, whereas

$$△ {k}_{F , i}^{T o m b o} ( \cdot )$$

is more complicated to fit and is treated as an unknown mapping in this case. The torque coefficients can be decomposed in a similar fashion, with the averaged nominal coefficient denoted by

$${\overline{k}}_{M}^{T o m b o} .$$

The nominal coefficients

$${\overline{k}}_{F}^{T o m b o} and {\overline{k}}_{M}^{T o m b o}$$

are used in motor control to determine the rotational speed of each rotor ω_{c,i} from the commanded thrust T_{c,i} (which can be uniquely determined from the commanded total thrust and moment (T_{c}, M_{c}) via motor mixing, such that

$${ω}_{c , i} = \sqrt{{T}_{c , i} / {\overline{k}}_{F}^{T o m b o}} .$$

However, the presence of the variable coefficients

$$Δ {\overline{k}}_{F , i}^{T o m b o}$$

results in extra thrusts generated, leading to an actual thrust T_{a,i} of motor i being

$${T}_{a , i} = {T}_{c , i} + △ {k}_{F , i}^{Tombo} ( {ω}_{c , i} ) {ω}_{c , i}^{2} . \qquad ( 5 )$$

Likewise, the extra reaction torque will be generated due to the variable torque coefficient

$$△ {k}_{M , i}^{Tombo} ( \cdot ) ,$$

which impacts the z-axis moment in the body frame. The actual moment is then

$${M}_{a} = {M}_{c} + Λ ( △ {k}_{F , i}^{Tombo} , △ {k}_{M , i}^{Tombo} ) {ω}^{2} , \qquad ( 6 )$$

TABLE III
Parameters of system 100 and controller.

| param. | value | | param | value |
|---|---|---|---|---|
| m | 1.18 | kg | J | 10⁻³diag(12.6, 8.1, 18.1) kgm² |
| g | 9.81 | m/s² | Kₚ | diag(18.5, 15, 16) |
| T_{S} | 0.0025 | s | Kᵥ | diag(2.5, 1.3, 3.2) |
| β_{C}(f) | 30 | rad/s | K_{R} | 10⁻¹ diag(8.8, 1.6, 10) |
| β_{C}(M) | 2, 4 | rad/s | K | 10⁻² diag(45, 39, 3.28) |
| | | | A_{S} | −diag(20, 20, 20, 20, 20, 20) |

where Λϵ [symbol] ^{3×4} denotes the linear mapping from the squared motor speeds to the moments due to the variable coefficients and

$${ω}^{2} = {[ {ω}_{1}^{2} , {ω}_{2}^{2} , {ω}_{3}^{2} , {ω}_{4}^{2} ]}^{⊤} .$$

Another factor affecting the flight performance of the quadrotor 101 can include the significant current drain due to the higher drag of the collision-compliant propeller 102 compared with a conventional rigid propeller of the same size. Considering that the battery can be modeled with internal resistance, the current drain leads to voltage fluctuation. One can denote the constant value of voltage in the thrust/torque coefficients identification as Vₙₒₘ and the actual voltage driving the collision-compliant-equipped motors by Vₐ. Since the propeller's thrust (and reaction torque) are proportional to squared motor speed, and the motor speed is proportional to the voltage Vₐ, the actual thrust generated can be scaled by (Vₐ/Vₙₒₘ)², which results in

$${( \frac{{V}_{a}}{{V}_{nom}} )}^{2} {T}_{a , i} and {( \frac{{V}_{a}}{{V}_{nom}} )}^{2} {M}_{a} .$$

One of the standout features of collision-compliant propellers can be an ability to absorb and recover from collisions. However, these collisions introduce impact moments that can potentially destabilize the quadrotor 101. The collision-induced moment can be denoted by M_{collision}, which disturbs the rotational dynamics in (1b).

Based on the analysis above, the uncertainties experienced by the collision-compliant propeller can be considered actuation-induced uncertainties, and the collision moment M_{collision} belongs to external disturbances. These factors can be concluded as matched uncertainties σₘ in Equation (7), i.e.,

$${σ}_{m} = [ \begin{matrix}{( \frac{{V}_{a}}{{V}_{nom}} )}^{2} {\sum }_{i = 4}^{4} {T}_{a , i} - {T}_{c} + △ T \\ {( \frac{{V}_{a}}{{V}_{nom}} )}^{2} {\sum }_{i = 4}^{4} {M}_{a} - {M}_{c} + {M}_{collision} + △ M\end{matrix} ] , \qquad ( 7 )$$

where ΔT is a scalar and ΔM is a three-dimensional vector, which are the lumped thrust and moment, respectively, caused by the other factors that are not included in this analysis. Following Equation (7), the [symbol] ₁ Quad is well fitted to compensate for the induced uncertainties and external disturbances.

FIG. 1C is an example quadrotor model 101C consistent with the quadrotor 101 of FIG. 1A according to some embodiments. In some embodiments, the [symbol] ₁ Quad architecture can be employed to address uncertainties and disturbances in quadrotor 101. The [symbol] ₁ Quad architecture can be an application of the [symbol] ₁ adaptive control component 120, which enlarges the flight envelope of a quadrotor 101 subject to uncertainties and disturbances. The [symbol] ₁ Quad applies to the dynamics (1b) of the quadrotor equation of motion, since the kinematics (la) are integrators and hence considered as uncertainty-free. One can thus denote the full state as follows (with additional reference to FIG. 1C), x=[p^{⊥} v^{⊥} vec(R)^{⊥} Ω^{⊥}]^{⊥}ϵ [symbol] ¹⁸ and the partial state as z=[v^{⊥} Ω^{⊥}]^{⊥}ϵ [symbol] ⁶.

One can rewrite the dynamics of Equation (1b) in a state-space form with the partial state z as follows

$$\dot{z} ( t ) = f ( z ( t ) ) + B ( R ( t ) ) ( {u}_{c} ( t ) + {u}_{ad} ( t ) + {σ}_{m} ( t , x ( t ) ) ) + {B}^{⊥} ( R ( t ) ) {σ}_{um} ( t , x ( t ) ) , \qquad ( 8 )$$

where

$$f ( z ) = [ \begin{matrix}{ge}_{3} \\ - {J}^{- 1} Ω xJ Ω\end{matrix} ]$$

is a vector-valued function describing the evolution of the partial state z on its own

$$B ( R ) = [ \begin{matrix}- {m}^{- 1} {Re}_{3} {0}_{3 \times 3} \\ {0}_{3 \times 3} {J}^{- 1}\end{matrix} ]$$

is a matrix-valued function describing the influence of the controls u_{c} and u_{ad} and matched uncertainty σₘ to the partial state z, and

$${B}^{⊥} ( R ) = [ \begin{matrix}{m}^{- 1} {Re}_{1} & {m}^{- 1} {Re}_{2} \\ {0}_{3 \times 1} & {0}_{3 \times 1}\end{matrix} ]$$

is a matrix-valued function describing the influence of the unmatched uncertainty σᵤₘ to the partial state z.

FIG. 1C illustrates the dynamical process described by Equation (8). The collision-induced disturbances and generic uncertainties and disturbances enter the system through σ, whereas the control signal enters via u. The change rate ż of the partial state z is the summation of the evolution of the partial state itself, denoted by f(z), contributions from the control, denoted by B(R)(u_{c}+u_{ad}), and uncertainties and disturbances, denoted by B(R)πₘ and B_{⊥}(R)σᵤₘ. The integral symbol ∫ indicates the integration of change rate ż to partial state z and further integration to the positional state p and R. The positional states are concatenated together with the partial state z to form the full state x, which is then fed back to the geometric control component 110. The partial state z can be fed to the L1 adaptive control to produce the adaptive control signal u_{ad}. The control

$${u}_{c} = {[ {T}_{c} , {M}_{c}^{⊤} ]}^{⊤}$$

can be a four-dimensional vector denoting the control actions following the geometric control component 110. The matched and unmatched uncertainties can be denoted by σₘ (as a four-dimensional vector) and σᵤₘ (as a two-dimensional vector), respectively. The matched uncertainty σₘ affects the system 100 through the same channel as the geometric control u_{c}. Therefore, σₘ can be directly compensated for by the control actions to the quadrotor 101. In contrast, the unmatched uncertainty σᵤₘ, contains forces along any direction in the body-xy plane, which enters the dynamics via B^{⊥}(R) (whose columns are orthogonal to those of B(R)). For the Tombo quadrotor, the matched uncertainty σₘ have the form displayed in Equation (7).

As was discussed, in some embodiments, the [symbol] ₁ adaptive control component 120 includes the state predictor 124, the adaptation law 122, and the low-pass filter (LPF) 128 as illustrated in FIG. 1A. In some embodiments, the state predictor 124 is expressed as

$$\dot{\hat{z}} ( t ) = f ( z ( t ) ) + B ( R ( t ) ) ( {u}_{b} ( t ) + {u}_{ad} ( t ) + {\hat{σ}}_{m} ( t ) ) \qquad ( 9 )$$

$$+ {B}^{⊥} ( R ( t ) ) {\hat{σ}}_{um} ( t ) + {A}_{s} \tilde{z} ( t ) ,$$

where \tilde{z}=\hat{z}−z is the prediction error and Aₛ is a 6-by-6 Hurwitz matrix that can be selected by a user. The state predictor 124, as expressed in Equation (9), replicates the structure in Equation (8) and replaces the unknown uncertainties \hat{σ}ₘ and \hat{σ}ᵤₘ by their estimates \hat{σ}ₘ and \hat{σ}ᵤₘ, respectively. We use the piecewise-constant adaptation law 122 to compute the estimated uncertainty such that for tϵ[kTₛ, (k+1)Tₛ)], we have

$$\hat{σ} ( t ) = \hat{σ} ( {kT}_{s} ) = - {\overline{B} ( {kT}_{s} )}^{- 1} {( {A}_{s}^{- 1} ( exp ( {A}_{s} {T}_{s} ) - I ) )}^{- 1} exp ( {A}_{s} {T}_{s} ) \tilde{z} ( {kT}_{s} ) , \qquad ( 10 )$$

where

$$\hat{σ} = {[ \begin{matrix}{\hat{σ}}_{m}^{⊤} & {\hat{σ}}_{um}^{⊤}\end{matrix} ]}^{⊤}$$

denotes the stacked uncertainty estimation \hat{σ}ₘ and \hat{σ}ᵤₘ, Tₛ is a scalar denoting the sampling time, B̅(kTₛ)=[B(R(kTₛ)) B^{⊥}(R(kTₛ))] is the concatenation of the matrix B and B^{⊥}, both evaluated at time kTₛ for an integer valued k. By setting the sampling time Tₛ small enough (up to the hardware limit), one can achieve arbitrarily accurate uncertainty estimation. Finally, the [symbol] ₁ adaptive control law u_{ad} is computed (in the frequency domain) by u_{ad}(s)=−C(s)\hat{σ}ₘ(s), where u_{ad} only compensates for the matched uncertainty \hat{σ}ₘ within the bandwidth β of the LPF 128 with transfer function C(s) and where s is the complex frequency variable.

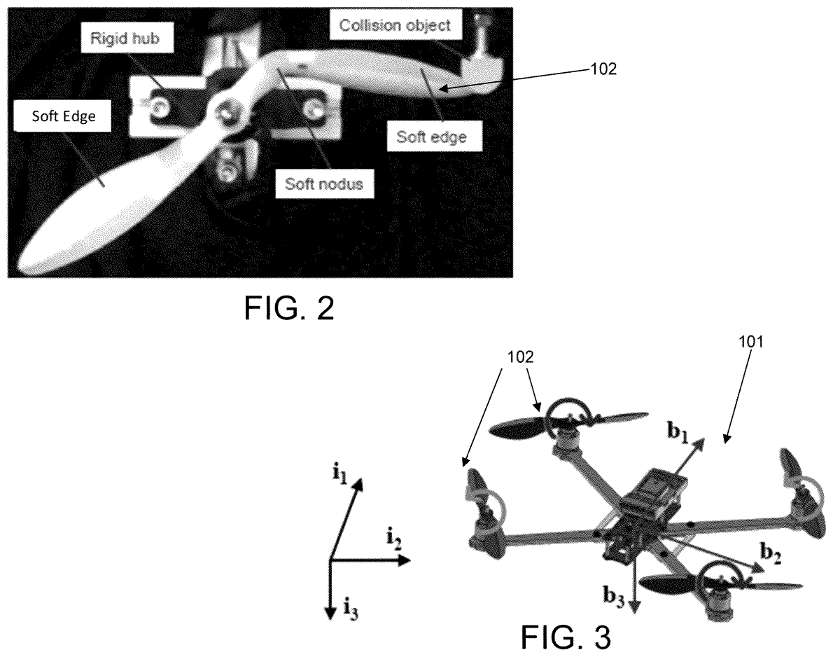

FIG. 4 is an implementation guide of an algorithm (Algorithm 1) of the [symbol] ₁ Quad architecture according to some embodiments. As can be observed, Algorithm 1 can step through a series of operations, including updating the state predictor 124, updating the state prediction error (\tilde{z}), computing h(k), computing the estimated uncertainty, filtering the matched uncertainty estimate and negating the filtered signal to obtain the [symbol] ₁ adaptive control component 120. The output can be returned as the [symbol] ₁ adaptive control, or u_{ad}(k).

We experimentally validated the performance of a collision-compliant quadrotor 101 and the [symbol] ₁ Quad in both collision-free and collision-involved flights. For collision-involved flights, we compare the performance of the same quadrotor equipped with rigid and collision-compliant propellers to assess the efficacy of collision compliance of the synergy of collision-compliant propellers and [symbol] ₁ Quad. We considered three collision scenarios: i) impact with a freely suspended foam bar, ii) impact with a carbon fiber bar, and iii) a severe collision involving the intrusion of a carbon fiber rod into the center of the propeller. They represent gradually increasing levels of collision severity for a comprehensive assessment of the quadrotor's resilience to collisions.

For experimentation, we use a custom-built quadrotor with the Lumenier QAVRXL 2-10″ FPV frame, four 2216 1120 KV BLDC motors, and a 4S LiPo battery. We use four 30 ampere (A) electrical speed controllers for motor control. The flight controller is a Pixhawk 6X with customized Ardupilot firmware. The actual position of the quadrotor is obtained from a system of 9 Vicon V16 cameras. The [symbol] ₁ Quad updates the control commands at 400 Hz. The system specifications and controller parameters are presented in Table III. The values of the geometric control parameters are tuned using DiffTune to provide satisfactory tracking performance.

Trajectory tracking with the [symbol] ₁ Quad in collision-free flights was performed. We conducted experiments for the quadrotor 101 using the collision-compliant propellers 102 with [symbol] ₁ control on and off. The quadrotor 101 tracks circular and lemniscate trajectories with (max) linear speeds of 1 m/s and 1.5 m/s. The position tracking is evaluated by the root-mean-squared error (RMSE), when [symbol] ₁ control is on or off, shown in Table IV, which tracks RMSE of the quadrotor 101 with [symbol] ₁ control on and off in collision-free flight. It can be seen that with [symbol] ₁ control on, the tracking error is significantly reduced in all four cases, with the most substantial reduction on the z-axis. This phenomenon is expected because the [symbol] ₁ adaptive control compensates for the matched uncertainties in the body z-axis induced by the uncertain thrust coefficients of the collision-compliant propellers 102.

TABLE IV

| | Traj. | | | | | | | |
|---|---|---|---|---|---|---|---|---|
| | Circle | | | | Lemniscate | | | |
| | Speed | | | | | | | |
| | 1 m/s | | 1.5 m/s | | 1 m/s | | 1.5 m/s | |
| L₁ | off | on | off | on | off | on | off | on |
| x | 0.14 | 0.07 | 0.15 | 0.13 | 0.13 | 0.08 | 0.10 | 0.06 |
| y | 0.10 | 0.06 | 0.14 | 0.12 | 0.14 | 0.11 | 0.11 | 0.06 |
| z | 0.14 | 0.01 | 0.12 | 0.02 | 0.11 | 0.02 | 0.10 | 0.01 |

Collision with A Foam Bar

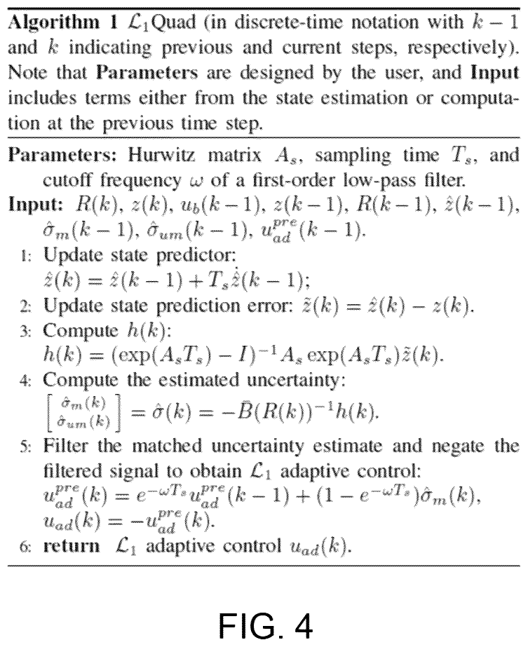

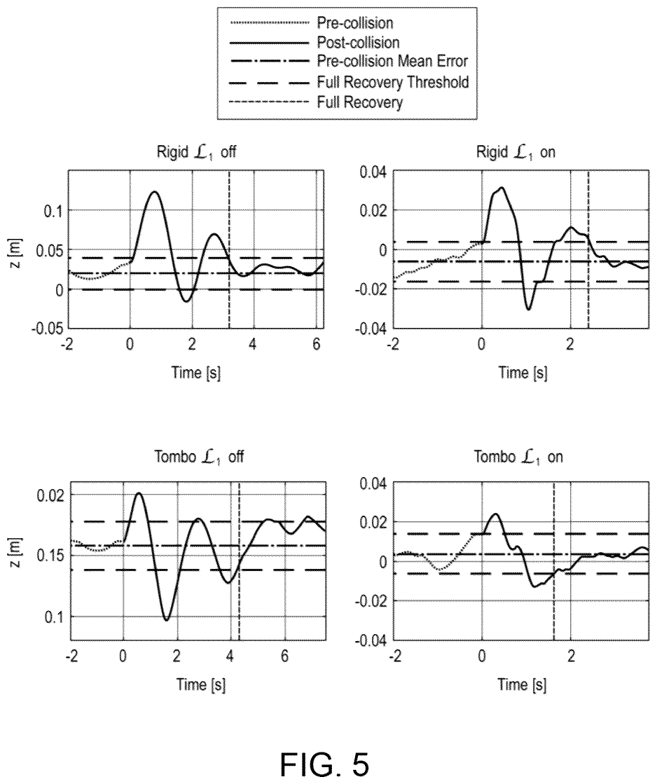

In this experiment, we evaluate the robustness of [symbol] ₁ Quad during random collisions between the quadrotor (using Tombo and rigid propellers) and a foam bar. Four scenarios are tested: “Rigid [symbol] ₁ off,” “Rigid [symbol] ₁ on,” “Tombo [symbol] ₁ off,” and “Tombo [symbol] ₁ on,” where the names suggest combinations of propellers equipped and the state of [symbol] ₁ adaptive control. The quadrotor follows a 1-meter-radius horizontal circular trajectory with 1 m/s linear speed, which collides with a suspended foam bar (52 mm diameter, 1250 mm length) that intersects with the circular trajectory (illustrated in FIG. 6A). We use two metrics for evaluating the system's post-collision performance: recovery time and maximum deviation distance during collisions, which are defined as follows. Recovery time is defined as the duration from the instant of collision to the full recovery, as illustrated in FIG. 5. The start of the collision is identified by the abrupt change in acceleration signals recorded by the onboard IMU. Full recovery is defined as the status in which the quadrotor's altitude (z-axis position) falls within a threshold with respect to the pre-collision steady-state, for which we detail the threshold values in the caption of FIG. 5, e.g., as pre-collision, post-collision, pre-collision mean error, full recovery threshold, and full recovery. Meanwhile, the maximum deviation distance can be defined as the maximum positional error of the quadrotor relative to the desired position during the recovery period defined above.

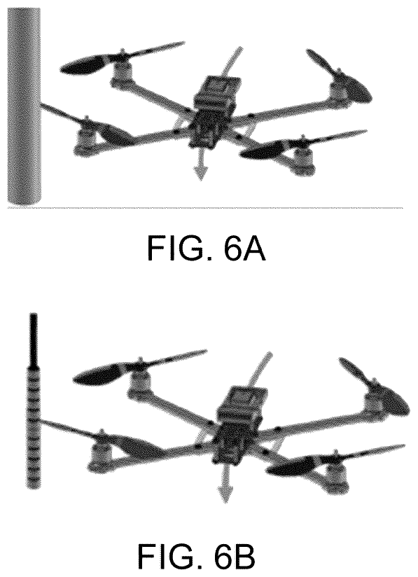

The results are statistically analyzed and shown in FIG. 7A. It is evident that the most favorable post-collision performance is observed in the case of “Tombo [symbol] ₁ on,” followed by “Rigid [symbol] ₁ on,” “Rigid [symbol] ₁ off,” and the worst is “Tombo [symbol] ₁ off.” This conclusion holds when it is examined by both metrics. The average collision recovery time in the four cases “Tombo [symbol] ₁ off,” “Rigid [symbol] ₁ off,” “Rigid [symbol] ₁ on,” and “Tombo [symbol] ₁ on” is 4.34 s, 3.71 s, 2.19 s, and 1.57 s, respectively, while the average maximum deviation distance is 0.324 m, 0.199 m, 0.146 m, and 0.133 m, respectively.

The superior performance of “Tombo [symbol] ₁ on” is attributed to the combination between collision-compliant (or “Tombo”) propellers and [symbol] ₁ adaptive control. First, the soft material on the edge and nodus of the collision-compliant propeller reduces the impact force on both the propeller and the entire quadrotor. Second, [symbol] ₁ adaptive control's fast adaptation mitigates the impact with a rapid recovery. This is evident from the results showing better performance with both rigid and collision-compliant propellers when [symbol] ₁ is on. Additionally, the effectiveness of [symbol] ₁ adaptive control's compensation for the unique physical characteristics of the collision-compliant propellers is also clear from drastically different flight performance between “Tombo [symbol] ₁ on” (best) and “Tombo [symbol] ₁ off” (worst).

Collision with a Carbon Fiber Bar

This experiment is set up similarly to the previous collision experiment, with the foam bar replaced by a carbon fiber bar, illustrated in FIG. 6B. The carbon fiber bar is a hollow rectangular tube with outer dimensions of 8×8 mm and a length of 1000 mm. We wrap a thin layer of foam around the impact area of the carbon fiber bar to partially reduce the collision force, as neither the rigid propellers nor Tombo propellers can survive a direct collision with the carbon fiber bar. The statistics of recovery time and the maximum deviation distance are summarized in FIG. 7B. The results in the four scenarios are similar to those observed in the foam-bar-collision experiments, where “Tombo [symbol] ₁ on” demonstrates the best performance evaluated by both metrics. The average collision recovery time for the four cases “Tombo [symbol] ₁ off,” “Rigid [symbol] ₁ off,” “Rigid [symbol] ₁ on,” and “Tombo [symbol] ₁ on” are 4.5 s, 3.00 s, 2.52 s, and 2.08 s, respectively, while the average maximum deviation distance was 0.317 m, 0.229 m, 0.166 m and 0.135 m, respectively.

Collisions with the carbon fiber bar often result in breakage at the tip of the rigid propellers. The severity depends on the position of the propeller at the moment of impact. However, due to the high rotational speed of the propellers, the breakage typically occurred very close to the tip, leading to insignificant impacts on the flight after the collision. In the case of “Rigid [symbol] ₁ on,” the [symbol] ₁ adaptive control can effectively compensate for the minor thrust loss from the propeller tip damage. However, the impact forces in collision with the rigid propellers were greater than those with the Tombo propellers, resulting in the best response to be observed under “Tombo [symbol] ₁ on.”

### Severe Collision During Hover Flight

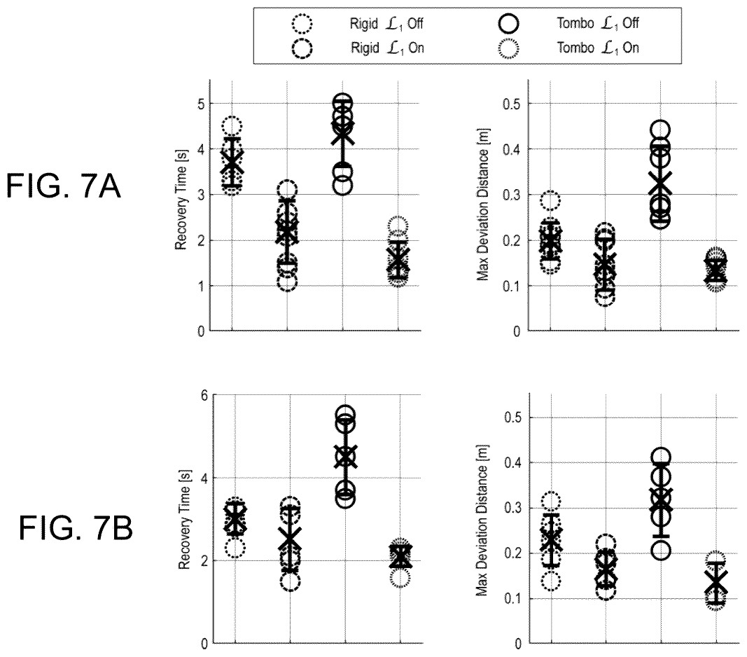

After the evaluation of [symbol] ₁ adaptive control and the Tombo propeller's ability to mitigate impacts from the collision with foam and carbon fiber bars, we design and execute a more challenging scenario as follows. This experiment seeks to further demonstrate that the combination of [symbol] ₁ adaptive control with a collision-compliant propeller significantly enhances collision recovery capability, compared to the conventional usage of rigid propellers without the [symbol] ₁ adaptive control. This experiment is motivated by scenarios where a drone, during vertical flight, encounters obstacles such as branches or power lines that intrude into the propeller's path. The setup involved a 1058 mm×28 mm×28 mm wooden bar, vertically connected to a hollow carbon fiber rod of 238 mm in length and 5.47 mm in radius. The drone hovered 1 meter above its takeoff point, and the carbon fiber rod intruded into the propeller's path, which is illustrated in FIG. 8.

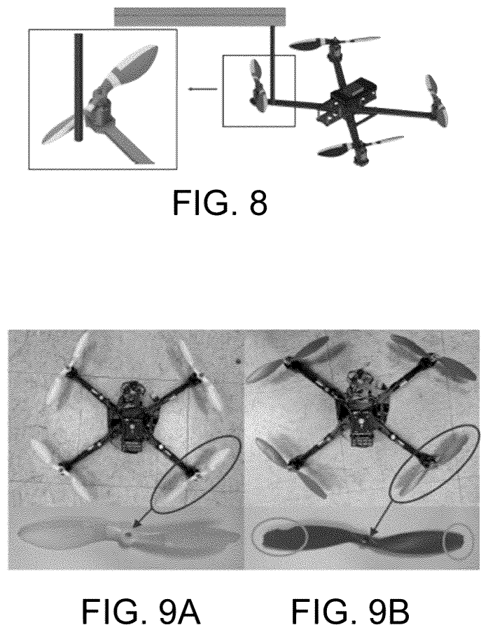

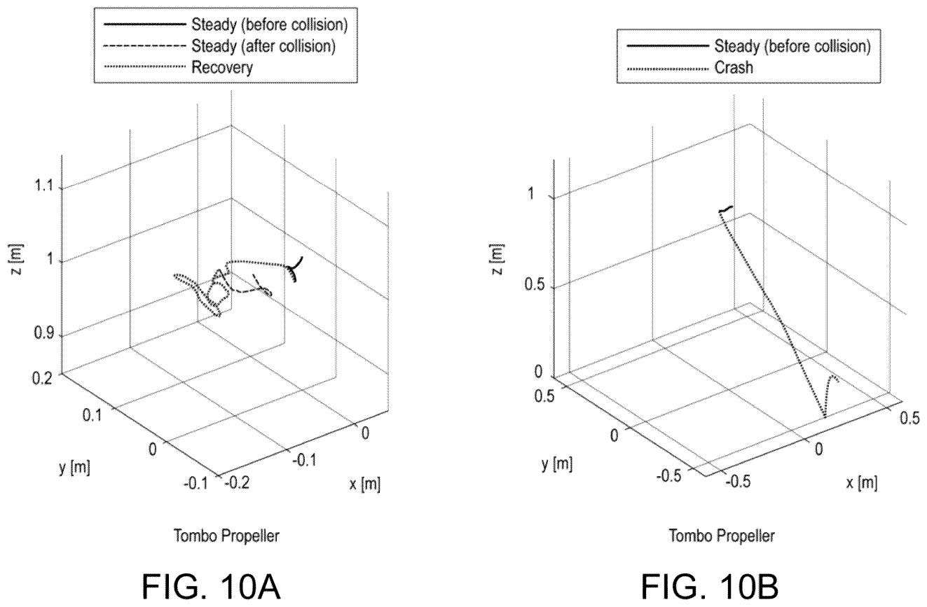

The collision-compliant propeller 102, with its resilience to severe impacts, enabled the drone to withstand up to three severe collisions without breaking, ensuring that the propeller remained intact and capable of staying operational (shown in FIG. 9A). This characteristic is particularly advantageous compared to rigid propellers, which fracture under the same conditions, leading to a loss of control (shown in FIG. 9B). FIG. 10A is a graph of trajectory of a quadrotor in a severe collision with soft propellers according to an embodiment. FIG. 10B is a graph of trajectory of the quadrotor in a severe collision with rigid propellers according to an embodiment.

However, the same flexibility that allows the collision-compliant propeller 102 to survive collisions also introduces unstable dynamics and perturbation thrusts into the system 100. The [symbol] ₁ adaptive control helps stabilize the drone by effectively suppressing the oscillations that occur during sudden decelerations and accelerations of the propellers.

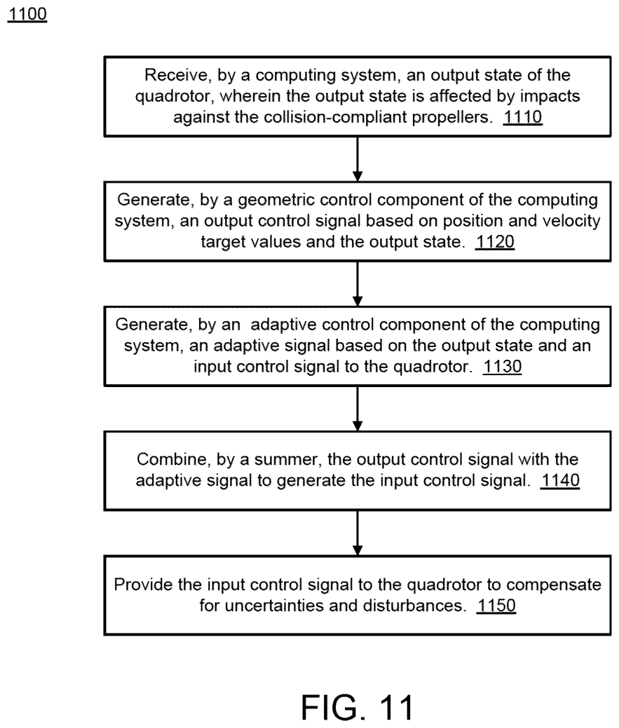

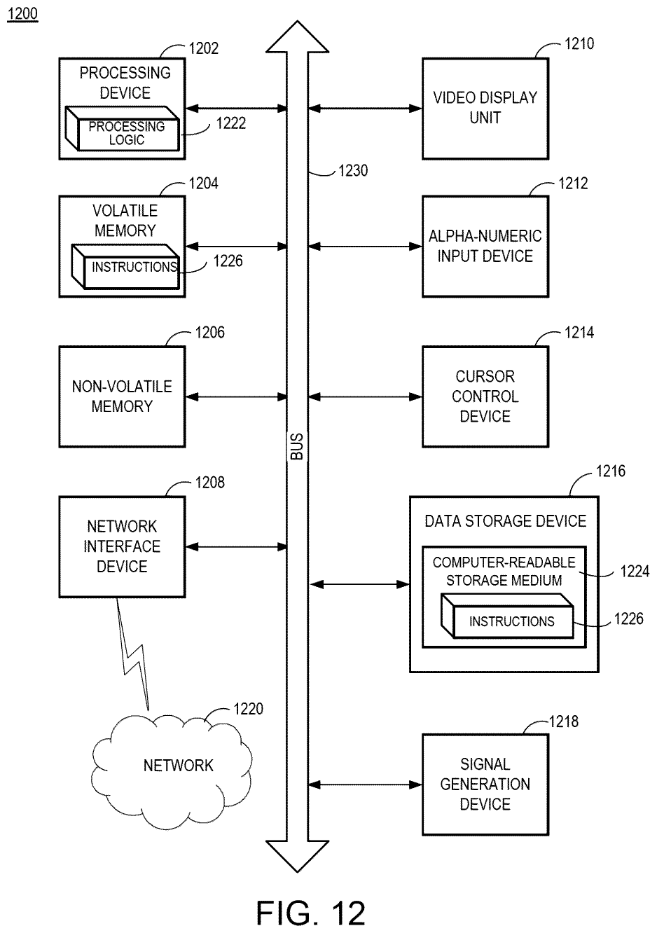

FIG. 11 is a flow chart of a method 1100 for operating a control feedback system employing the [symbol] ₁ Quad architecture of a quadrotor using the collision-compliant (or Tombo) propeller according to some embodiments. The method 1100 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 1100 is performed by a computer system or device such as the computer device 1200 (FIG. 12), which can implement the feedback control system 100 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 1110, the computing system receives an output state of the quadrotor, wherein the output state is affected by impacts against the collision-compliant propellers. In some embodiments, the collision-compliant propellers include a nodus made of soft material configured to deform upon impact with an obstacle.

At operation 1120, a geometric control component of the computing system generates an output control signal based on position and velocity target values and the output state.

At operation 1130, an [symbol] ₁ adaptive control component of the computing system generates an adaptive signal based on the output state and an input control signal to the quadrotor. In some embodiments, the [symbol] ₁ adaptive control component includes a state predictor, an adaptation law, and a low-pass filter. The output state can include a translational state having a position vector and a velocity vector, and a rotational state including a rotation matrix and an angular velocity vector.

With additional reference to operation 1130, generating the adaptive signal can include generating predicted output states based on a nominal model of the quadrotor, determining a difference between the predicted output states and the output state of the quadrotor, estimating uncertainties based on the difference, and filtering the estimated uncertainties through a low-pass filter to generate the adaptive signal. In embodiments, estimating uncertainties can include estimating matched uncertainties that affect the quadrotor through a same channel as the output control signal. The matched uncertainties can include thrust uncertainties caused by variable thrust coefficients of the collision-compliant propellers, moment uncertainties caused by variable torque coefficients of the collision-compliant propellers, voltage fluctuation effects on thrust generation, and/or collision-induced moments.

At operation 1140, a summer combines the output control signal with the adaptive signal to generate the input control signal.

At operation 1150, the computing system provides the input control signal to the quadrotor to compensate for uncertainties and disturbances.

In some embodiments, the method 1100 is extended to include detecting a collision between at least one of the collision-compliant propellers and an obstacle based on a change in the output state and recovering flight stability after the collision using the [symbol] ₁ adaptive control component.

FIG. 12 illustrates a block diagram illustrating an exemplary computer device 1200 (or computing device), in accordance with implementations of the present disclosure. Computer device 1200 can, for example, implement the distributed grid control framework, as described above, to include the feedback control system 100 (FIG. 1). Example computer device 1200 can be connected to other computer devices in a LAN, an intranet, an extranet, and/or the Internet. Computer device 1200 can operate in the capacity of a server in a client-server network environment. Computer device 1200 can be a personal computer (PC), a set-top box (STB), a server, a network router, switch or bridge, or any device capable of executing a set of instructions (sequential or otherwise) that specify actions to be taken by that device. Further, while only a single example computer device is illustrated, the term “computer” shall also be taken to include any collection of computers that individually or jointly execute a set (or multiple sets) of instructions to perform any one or more of the methods discussed herein.

Example computer device 1200 can include a processing device 1202 (also referred to as a processor, CPU, or GPU), a volatile memory 1204 (or main memory, e.g., read-only memory (ROM), flash memory, dynamic random access memory (DRAM) such as synchronous DRAM (SDRAM), etc.), a non-volatile memory 1206 (e.g., flash memory, static random access memory (SRAM), etc.), and a secondary memory (e.g., a data storage device 1216), which can communicate with each other via a bus 1230.

Processing device 1202 (which can include processing logic 1222) represents one or more general-purpose processing devices such as a microprocessor, central processing unit, or the like. More particularly, processing device 1202 can be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 1202 can also be one or more special-purpose processing devices such as an ASIC, a FPGA, a digital signal processor (DSP), network processor, or the like. In accordance with one or more aspects of the present disclosure, processing device 1202 can be configured to execute instructions performing the method disclosed herein.

Example computer device 1200 can further comprise a network interface device 1208, which can be communicatively coupled to a network 1220. Example computer device 1200 can further comprise a video display 1210 (e.g., a liquid crystal display (LCD), a touch screen, or a cathode ray tube (CRT)), an alphanumeric input device 1212 (e.g., a keyboard), a cursor control device 1214 (e.g., a mouse), and an acoustic signal generation device 1218 (e.g., a speaker).

Data storage device 1216 can include a computer-readable storage medium (or, more specifically, a non-transitory computer-readable storage medium) 1224 on which is stored one or more sets of executable instructions 1226. In accordance with one or more aspects of the present disclosure, executable instructions 1226 can comprise executable instructions performing the method disclosed herein.

Executable instructions 1226 can also reside, completely or at least partially, within volatile memory 1204 and/or within processing device 1202 during execution thereof by example computer device 1200, volatile memory 1204 and processing device 1202 also constituting computer-readable storage media. Executable instructions 1226 can further be transmitted or received over a network via network interface device 1208.

While the computer-readable storage medium 1224 is shown in FIG. 12 as a single medium, the term “computer-readable storage medium” or “non-transitory computer-readable storage medium storing instructions” or “computer-readable instructions” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus can be specially constructed for the required purposes, or it can be a general-purpose computer system selectively programmed by a computer program stored in the computer system. Such a computer program can be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general-purpose systems can be used with programs in accordance with the teachings herein, or it can prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages can be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but can be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

Other variations are within the scope of the present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within the range, unless otherwise indicated herein, and each separate value is incorporated into the specification as if it were individually recited herein. In at least one embodiment, the use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in an illustrative example of a set having three members, conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, the number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. In at least one embodiment, a set of non-transitory computer-readable storage media comprises multiple non-transitory computer-readable storage media and one or more of individual non-transitory storage media of multiple non-transitory computer-readable storage media lack all of the code while multiple non-transitory computer-readable storage media collectively store all of the code. In at least one embodiment, executable instructions are executed such that different instructions are executed by different processors.

Accordingly, in at least one embodiment, computer systems are configured to implement one or more services that singly or collectively perform operations of processes described herein, and such computer systems are configured with applicable hardware and/or software that enable the performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

In description and claims, the terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to actions and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transform that electronic data into other electronic data that may be stored in registers and/or memory. As non-limiting examples, a “processor” may be a network device. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, the terms “system” and “method” are used herein interchangeably insofar as the system may embody one or more methods, and methods may be considered a system.

In the present document, references may be made to obtaining, acquiring, receiving, or inputting analog or digital data into a sub-system, computer system, or computer-implemented machine. In at least one embodiment, the process of obtaining, acquiring, receiving, or inputting analog and digital data can be accomplished in a variety of ways, such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface, or an inter-process communication mechanism.

Although descriptions herein set forth example embodiments of described techniques, other architectures may be used to implement described functionality, and are intended to be within the scope of this disclosure. Furthermore, although specific distributions of responsibilities may be defined above for purposes of description, various functions and responsibilities might be distributed and divided in different ways, depending on circumstances.

Furthermore, although the subject matter has been described in language specific to structural features and/or methodological acts, it is to be understood that the subject matter claimed in appended claims is not necessarily limited to specific features or acts described. Rather, specific features and acts are disclosed as exemplary forms of implementing the claims.

What is claimed is:

1. A feedback control system comprising:
a quadrotor equipped with collision-compliant propellers;
a computing system coupled to the quadrotor, the computing system configured to:
implement a geometric control component responsive to position and velocity target values in relation to an output state of the quadrotor, wherein the output state is affected by impacts against the collision-compliant propellers; and
implement an [symbol] ₁ adaptive control control component that is responsive to a combination of the output state and an input control signal to the quadrotor; and
a summer to generate the input control signal, wherein the summer combines an output control signal of the geometric control component with an adaptive signal of the [symbol] ₁ adaptive control component such as to compensate for uncertainties and disturbances using the [symbol] ₁ adaptive control component.

2. The feedback control system of claim 1, wherein the [symbol] ₁ adaptive control component comprises:
a state predictor configured to generate predicted output states based on a nominal model of the quadrotor;
an adaptation law configured to estimate uncertainties based on a difference between the predicted output states and the output state of the quadrotor; and
a low-pass filter configured to filter the estimated uncertainties to generate the adaptive signal.

3. The feedback control system of claim 2, wherein the adaptation law is configured to estimate matched uncertainties that affect the quadrotor through a same channel as the output control signal of the geometric control component.

4. The feedback control system of claim 3, wherein the matched uncertainties comprise at least one of:
thrust uncertainties caused by variable thrust coefficients of the collision-compliant propellers;
moment uncertainties caused by variable torque coefficients of the collision-compliant propellers;
voltage fluctuation effects on thrust generation; or
collision-induced moments.

5. The feedback control system of claim 2, wherein the adaptation law is further configured to estimate unmatched uncertainties that affect the quadrotor through a channel orthogonal to a channel of the output control signal.

6. The feedback control system of claim 2, wherein the state predictor is configured to be updated at a sampling rate, and wherein a size of uniform bounds on tracking error is controllable by adjusting at least one of a bandwidth of the low-pass filter or the sampling rate.

7. The feedback control system of claim 1, wherein the collision-compliant propellers comprise a nodus made of soft material configured to fold upon impact with an obstacle.

8. The feedback control system of claim 1, wherein the output state of the quadrotor comprises:
a translational state including a position vector and a velocity vector of a center of mass of the quadrotor; and
a rotational state including a rotation matrix and an angular velocity vector.

9. The feedback control system of claim 8, wherein the geometric control component is configured to generate the output control signal based on a difference between the output state and the position and velocity target values, wherein the output control signal comprises a thrust command and a moment command.

10. The feedback control system of claim 1, wherein the [symbol] ₁ adaptive control component is configured to decouple an estimation loop from a control loop implemented by the geometric control component.

11. A method for controlling a quadrotor equipped with collision-compliant propellers, the method comprising:
receiving, by a computing system, an output state of the quadrotor, wherein the output state is affected by impacts against the collision-compliant propellers;
generating, by a geometric control component of the computing system, an output control signal based on position and velocity target values and the output state;
generating, by an [symbol] ₁ adaptive control component of the computing system, an adaptive signal based on the output state and an input control signal to the quadrotor;
combining, by a summer, the output control signal with the adaptive signal to generate the input control signal; and
providing the input control signal to the quadrotor to compensate for uncertainties and disturbances.

12. The method of claim 11, wherein generating the adaptive signal comprises:
generating predicted output states based on a nominal model of the quadrotor;
determining a difference between the predicted output states and the output state of the quadrotor;
estimating uncertainties based on the difference; and
filtering the estimated uncertainties through a low-pass filter to generate the adaptive signal.

13. The method of claim 12, wherein estimating uncertainties comprises estimating matched uncertainties that affect the quadrotor through a same channel as the output control signal.

14. The method of claim 13, wherein the matched uncertainties comprise at least one of thrust uncertainties caused by variable thrust coefficients of the collision-compliant propellers, moment uncertainties caused by variable torque coefficients of the collision-compliant propellers, voltage fluctuation effects on thrust generation, or collision-induced moments.

15. The method of claim 11, further comprising:
detecting a collision between at least one of the collision-compliant propellers and an obstacle based on a change in the output state; and
recovering flight stability after the collision using the [symbol] ₁ adaptive control component.

16. The method of claim 11, wherein the output state comprises a translational state including a position vector and a velocity vector, and a rotational state including a rotation matrix and an angular velocity vector.

17. The method of claim 11, further comprising causing the geometric control component to generate the output control signal based on a difference between the output state and the position and velocity target values, wherein the output control signal comprises a thrust command and a moment command.

18. A non-transitory computer-readable storage medium storing instructions that, when executed by one or more processors of a computing system, cause the computing system to perform operations comprising:
receiving an output state of a quadrotor equipped with collision-compliant propellers, wherein the output state is affected by impacts against the collision-compliant propellers;
generating, by a geometric control component, an output control signal based on position and velocity target values and the output state;
generating, by an [symbol] ₁ adaptive control component, an adaptive signal based on the output state and an input control signal to the quadrotor, wherein the [symbol] ₁ adaptive control component comprises a state predictor, an adaptation law, and a low-pass filter;
combining the output control signal with the adaptive signal to generate the input control signal; and
providing the input control signal to the quadrotor to compensate for uncertainties and disturbances.

19. The non-transitory computer-readable storage medium of claim 18, wherein generating the adaptive signal comprises:
generating, by the state predictor, predicted output states based on a nominal model of the quadrotor;
determining a difference between the predicted output states and the output state of the quadrotor;
estimating, by the adaptation law, matched uncertainties based on the difference; and
filtering, by the low-pass filter, the estimated matched uncertainties to generate the adaptive signal.

20. The non-transitory computer-readable storage medium of claim 19, wherein the matched uncertainties comprise at least one of thrust uncertainties caused by variable thrust coefficients of the collision-compliant propellers, moment uncertainties caused by variable torque coefficients of the collision-compliant propellers, voltage fluctuation effects on thrust generation, or collision-induced moments.
